(19) United States
(12) Patent Application Publication
(10) Pub. No.: US 2013/0179933 A1
(43) Pub. Date: Jul. 11, 2013

(54) HEADEND DEVICE FOR CABLE NETWORK AND METHOD OF OPERATING HEADEND DEVICE

(71) Applicant: Electronics and Telecommunications Research Institute, Daejeon (KR)

(72) Inventors: Ho Sook LEE, Daejeon (KR); Dong Joon CHOI, Daejeon (KR); Nam Ho HUR, Daejeon (KR)

(73) Assignee: Electronics and Telecommunications Research Institute, Daejeon (KR)

(21) Appl. No.: 13/734,656

(22) Filed: Jan. 4, 2013

(30) Foreign Application Priority Data
Jan. 5, 2012 (KR) 10-2012-0001522

(51) Int. Cl. H04N 21/258

(52) U.S. Cl. CPC H04N 21/258
USPC 725/116

(57) ABSTRACT

Disclosed is a headend device for a cable network and a method of operating the headend device. The headend device for a hybrid fiber coaxial (HFC)-based cable network may transmit a digital video data stream and an Internet Protocol (IP) data stream input using various input interface standards integratedly based on a frequency channel standard for the cable network to improve efficiency.

### CROSS-REFERENCE TO RELATED APPLICATION

This application claims the priority benefit of Korean Patent Application No. 10-2012-0001522, filed on Jan. 5, 2012, in the Korean Intellectual Property Office, the disclosure of which is incorporated herein by reference.

### BACKGROUND

1. Field of the Invention

Exemplary embodiments relate to a headend device for a cable network and a method of operating the headend device, and more particularly, to a headend device for a hybrid fiber coaxial (HFC)-based cable network.

2. Description of the Related Art

Generally, a digital video transmission service refers to a service for transmitting a video stream from a video server of a service network to a subscriber terminal through an edge quadrature amplitude modulation (EQAM) equipment of a hybrid fiber coaxial (HFC)-based cable network as a distribution network. The video stream may be a stream of moving pictures experts group (MPEG)-2 transport system (TS) packets. Conventionally, the digital video transmission service usually uses an MPEG-2 TS stream video service flow based on a broadcast transport scheme. The MPEG-2 TS stream video service flow may be such that one program is broadcast to a subscriber cell of a cable network through each frequency channel of the cable network.

Recently, various video transmission services have been developed and provided, for example, a multicast video transmission service using the Internet Protocol (IP), such as, for example, an IPTV service, an IP video service, a switched digital video (SDV) service provided to a limited subscriber group, and the like, and a video on demand (VoD) service, such as, for example, a video conference service. Also, to meet an increased demand for high-speed and high-capacity data transmission, a data over cable service interface specification (DOCSIS), a data transmission standard for a cable network, has been revised. Also, standards for physical transmission of video through a frequency channel of a cable network, for example, video EQAM, digital video broadcasting-cable (DVB-C), DVB-C2, and the like, have evolved rapidly based on frequency modulation/demodulation and coding schemes. Accordingly, different standards are being currently used in the market.

For processing of various services provided via a cable network using different standards, when an integrated cable network transmission system is used or interworking with a high-cost transmission system is applied, an economic burden may be present. This may involve a great deal of investment costs to install an independent high-performance transmission equipment in a headend for each transmission service.

### SUMMARY

An aspect of the present invention provides a headend device for a cable network and a method of operating the headend device that may transmit a digital video data stream and an Internet Protocol (IP) data stream input using various input interface standards integratedly based on a frequency channel standard for a hybrid fiber coaxial (HFC)-based cable network to improve efficiency.

According to an aspect of the present invention, there is provided a headend device for a cable network including an input processor to classify a data stream input in the cable network based on a type of service flow, a dynamic stream processing module to convert the classified data stream into a stream associated with a transmission standard for the cable network through a scheme corresponding to the type of service flow, and an output stream switching module to output the stream converted by the dynamic stream processing module as an input for a physical layer (PHY) module.

The dynamic stream processing module may convert the classified data stream into a stream associated with a moving picture experts group-transport stream (MPEG-TS) standard through the scheme corresponding to the service flow type.

The dynamic stream processing module may include a plurality of stream processing modules to convert the data stream classified by the input processor into a stream associated with the transmission protocol for the HFC cable network through different schemes.

The plurality of stream processing modules may be installed the dynamic stream processing module using a plug-in technique.

The plurality of stream processing modules may include at least one of a first module to process a data over cable service interface specification (DOCSIS) header of a data stream input via an IP network, a second module to perform a switched digital video (SDV) function on an input video stream through communication with an electronic program guide (EPG) server, and a third module to execute header processing for channel bonding.

The headend device may further include a control module to transmit, to the dynamic stream processing module, an instruction for a stream processing module to be used to convert the classified data stream among the plurality of stream processing modules.

The control module may transmit a provisioning signal to the output stream switching module after transmitting the instruction.

The control module may select a predetermined PHY module among a plurality of PHY modules, and may control the output stream switching module to output the data stream converted by the dynamic stream processing module as an input for the predetermined PHY module.

The control module may connect the predetermined PHY module among the plurality of PHY modules to the output stream switching module.

According to another aspect of the present invention, there is provided a method of operating a headend device for a cable network, the method including classifying a data stream input in the cable network based on a type of service flow, converting the classified data stream into a stream associated with a transmission standard for the cable network through a scheme corresponding to the type of service flow, and outputting the converted data stream as an input for a PHY module.

The converting of the classified data stream into the stream associated with the transmission standard for the cable network may include converting the classified data stream to into the stream associated with the transmission standard for the cable network using a stream processing module supporting a service flow type of the classified data stream among a plurality of stream processing modules.

The method may further include transmitting an instruction for a stream processing module to be used to convert the classified data stream among the plurality of stream processing modules based on a control input by an administrator.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a cable network to which a headend device is applied according to an embodiment of the present invention;

FIG. 2 is a diagram illustrating a headend device according to an embodiment of the present invention;

FIG. 3 is a flowchart illustrating a method of operating a headend device according to an embodiment of the present invention;

FIG. 4 is a diagram illustrating a headend device according to another embodiment of the present invention;

FIG. 5 is a diagram illustrating an input processor of FIG. 4; and

FIG. 6 is a diagram illustrating an output stream switching module of FIG. 4.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

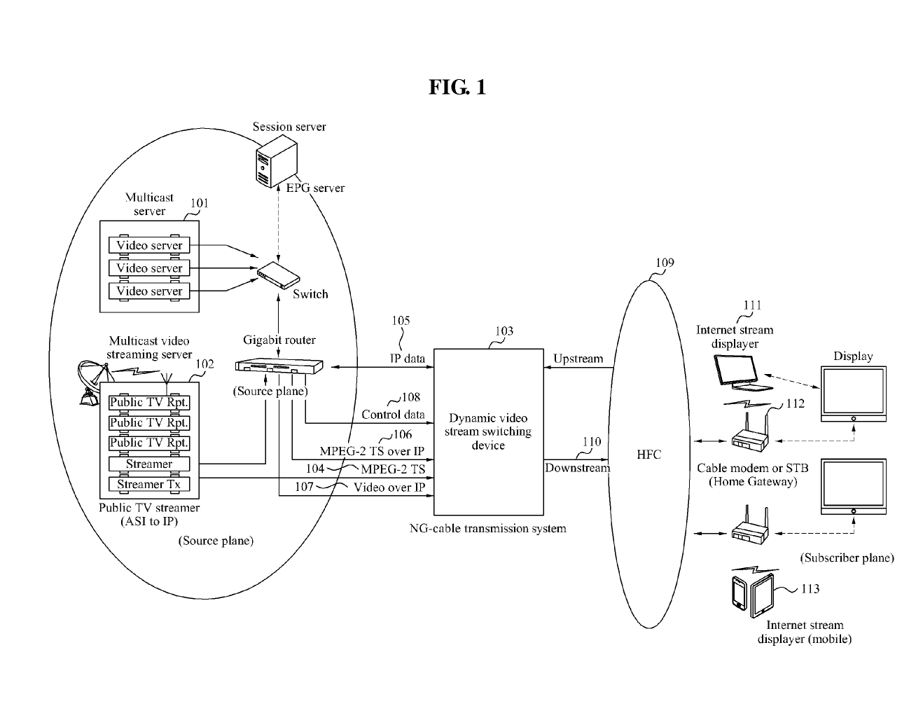

FIG. 1 is a diagram illustrating a cable network to which a headend device is applied according to an embodiment of the present invention. The cable network may correspond to a hybrid fiber coaxial (HFC)-based cable network.

Referring to FIG. 1, the HFC-based cable network 109 may extend from a dynamic video stream switching device 103 as a headend device.

The dynamic video stream switching device 103 may receive an input of data streams from servers related to video service providers. The data streams may include at least one of moving pictures experts group (MPEG)-2 transport stream (TS) 104 input through a video service flow from a multicast server 101 including video servers or a multicast video streaming server 102 including ground wave route servers, Internet Protocol (IP) data 105 input through an IP-based data flow in a data over cable service interface specification (DOCSIS), MPEG-2 TS over IP 106 input through an MPEG-2 TS video service flow via an IP network directly, video over IP 107 input through an IP-based video service flow, and control data 108 input through a control data flow for remote control.

The dynamic video stream switching device 103 may convert the received data streams into a stream associated with a single transmission protocol for a service flow to be outputted, and may output the single stream as an input for a physical layer (PHY) module supporting the HFC-based cable network 109.

Accordingly, a cable subscriber may be provided with an IP video streaming service interworking with an Internet stream displayer 111, a data service interworking with a cable modem/a set-top box (STB) 112, a video broadcast service interworking with an Internet stream displayer 113, through one cable network resource.

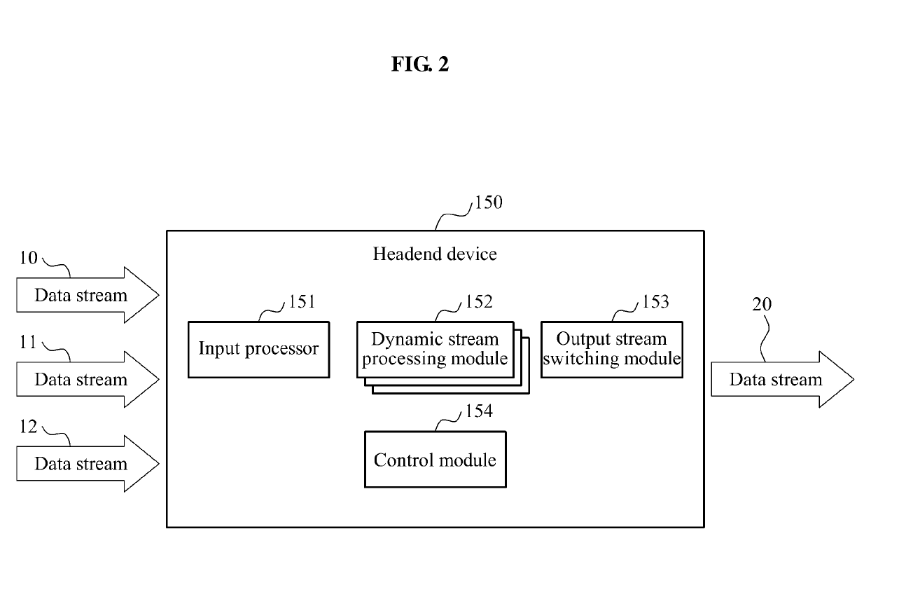

FIG. 2 is a diagram illustrating a headend device 150 according to an embodiment of the present invention.

Referring to FIG. 2, the headend device 150 may correspond to a dynamic video stream switching device 103 of FIG. 1, and may include an input processor 151, a dynamic stream processing module 152, and an output stream switching module 153. The headend device 150 may further include a control module 154. Also, the headend device 150 may receive an input of data streams 10 through 12 using various types of service flows.

The input processor 151 may classify data streams 10 through 12 input in the cable network, based on a type of service flow. The data streams 10 through 12 may include at least one of IP data, control data, MPEG-2 TS over IP, MPEG-2 TS, and video over IP. The input processor 151 may identify a type of service flow through which the data stream is input.

The dynamic stream processing module 152 may convert the classified data stream into a single standard stream through a scheme corresponding to the type of service flow. For example, the dynamic stream processing module 152 may convert the data stream classified by the input processor 151 into a stream associated with an MPEG-TS standard through a scheme corresponding to the type of service flow.

The dynamic stream processing module 152 may include a plurality of stream processing modules to convert the data stream classified by the input processor 151 into a stream associated with a transmission protocol for the HFC cable network through different schemes. The dynamic stream processing module 152 may convert the data stream input in the headhend device 150 into a stream associated with a transmission protocol for the HFC cable network using a stream processing module associated with a type of service flow of the input data stream among the plurality of stream processing modules.

The plurality of stream processing modules may be installed in the dynamic stream processing module 152 using a plug-in technique. As a support structure for the cable network may be expanded, the headend device 150 may be upgraded alone by installing a stream processing module.

The output stream switching module 153 may output the stream converted by the dynamic stream processing module 152 as an input for a PHY module. An output data stream 20 may be input in the cable network.

The plurality of stream processing modules may include at least one of a first module to process a DOCSIS header of a data stream input via an IP network, a second module to perform a switched digital video (SDV) function on a video stream input through communication with an electronic program guide (EPG) server, and a third module to execute header processing for channel bonding.

Also, the headend device 150 may select a stream processing module to be used by the dynamic stream processing module 152 among the plurality of stream processing modules automatically or by the control of an administrator. When the stream processing module is selected by the control of the administrator, the headend device 150 may further include the control module 154.

The control module 154 may transmit, to the dynamic stream processing module 152, an instruction for a stream processing module to be used to convert the data stream among the plurality of stream processing modules. That is, the control module 154 may interwork with an administrator interface, and may instruct the dynamic stream processing module 152 to use a predetermined stream processing module based on a control input by the administrator through the administrator interface. After the control module 154 transmits the instruction, the control module 154 may transmit a provisioning signal to the output stream switching module 153.

The dynamic stream processing module 152 may convert the classified data stream using the predetermined stream processing module among the plurality of stream processing modules by the control of the administrator. The output stream switching module 153 may be provisioned in advance of conversion being completed by the dynamic stream processing module 152.

The headend device 150 may support various types of PHY modules for the cable network. In this case, the control module 154 may select a predetermined PHY module among a plurality of PHY modules, and may instruct the output stream switching module 153 to output the data stream converted by the dynamic stream processing module 152 as an input for the predetermined PHY module. Also, the control module 154 may connect the predetermined PHY module among the plurality of PHY modules to the output stream switching module 153.

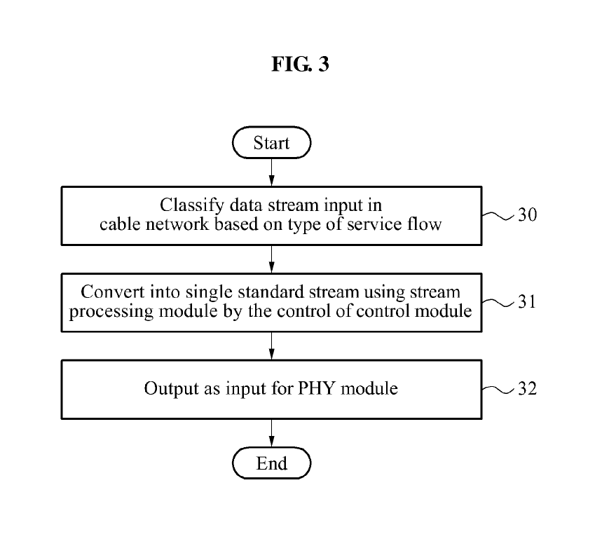

FIG. 3 is a flowchart illustrating a method of operating the headend device according to an embodiment of the present invention.

Referring to FIG. 3, in 30, the headend device may classify a data stream input in the cable network based on a type of service flow.

In 31, the headend device may convert the classified data stream into a single standard stream through a scheme corresponding to the type of service flow. In this instance, the headend device may convert the data stream into a single standard stream using a predetermined stream processing module among a plurality of stream processing modules by the control of an administrator. The stream processing modules may convert the data stream into a stream associated with an MPEG-TS standard through different schemes corresponding to a plurality of types of service flows. Accordingly, the headend device may convert the data stream classified in 30 through a scheme corresponding to each of the types of service flows.

In 32, the headend device may output the converted stream as an input for a PHY module.

The headend device may further include a control module to transmit an instruction for a stream processing module to be used to convert the classified data stream among the plurality of stream processing modules based on a control input by the administrator. The headend device may transmit a provisioning signal to a module to be executed in 32, that is, the output stream switching module so that the output stream switching module may be provisioned in advance.

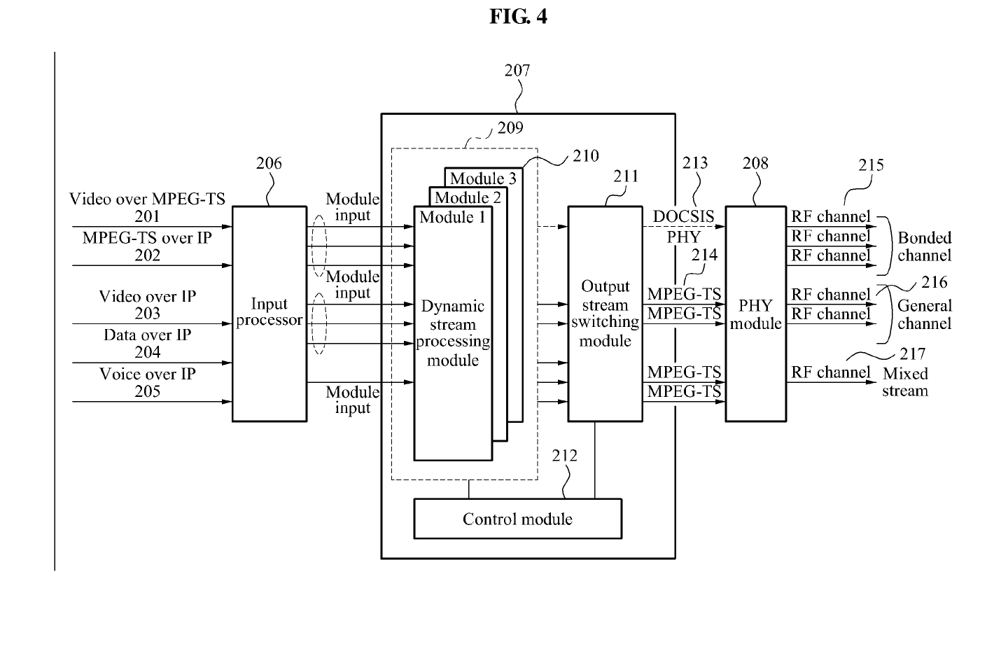

FIG. 4 is a diagram illustrating a headend device according to another embodiment of the present invention.

Referring to FIG. 4, the headend device may receive an input of data streams through various types of service flows. Particularly, the headend device may receive an input of a digital video data stream and an IP data stream. For example, the headend device may receive an input of at least one of video over MPEG TS 201, MPEG TS over IP 202, and IP data including video over IP 203, data over IP 204, and Voice over IP (VoIP) 205.

The headend device may modulate the input stream using a transmission standard for a cable network, and may transmit the modulated stream through a radio frequency (RF) channel of the cable network.

The headend device may include an input processor 206, a stream processor 207, and a PHY module 208. The stream processor 207 may include a dynamic stream processing module 209, an output stream switching module 211, and a control module 212.

The headend device may have a standard input and output format for the cable network. The headend device may execute input and output processing independent of dynamic stream processing module 209 and the independent PHY module 208. When the transmission standard for the cable network is changed or device expansion is required for an additional transmission service, the input processor 206 and the output stream switching module 211 may remain and the other components may be changed or added.

The dynamic stream processing module 209 may process a data stream transmitted from another network using a protocol for the another network. For this purpose, the dynamic stream processing module 209 may include a plurality of stream processing modules, and may convert the input data stream using a stream processing module associated with a type of service flow of the data stream input in the cable network, for example, a first module, among the plurality of stream processing modules.

When the data stream input in the cable network is an IP data stream, the dynamic stream processing module 209 may use a first module to process a DOCSIS header of the IP data stream. Also, the dynamic stream processing module 209 may use a second module to perform an SDV function on an input video stream through communication with an EPG server, and a third module to execute header processing for channel bonding.

The plurality of stream processing modules may be implemented as a single or composite module using a predetermined input and output standard. Also, the plurality of stream processing modules may be installed in the headend device using a plug-in technique. Accordingly, the headend device may add a transmission service of the network through the plug-in expansion.

The dynamic stream processing module 209 may be controlled by the control module 212. The control module 212 may transmit, to the dynamic stream processing module 209, an instruction for a stream processing module to be used among the plurality of stream processing modules. Also, the control module 212 may transmit a provisioning signal to the output stream switching module 211.

In response to the provisioning signal of the control module 212, the output stream switching module 211 may convert MPEG-2 TS streamed out from the dynamic stream processing module 209 into an input stream for the PHY module 208. The output stream switching module 211 may map MPEG-2 TS streamed out from the dynamic stream processing module 209 based on the physical transmission characteristics of a cable channel, and may output the stream.

Accordingly, the headend device of the present invention may convert data streams input in the cable network through various types of service flows into a suitable stream using a standard input and output processing scheme, and may output the converted stream using at least one output scheme of the PHY module. The headend device of the present invention may be more competitive and economically efficient than a conventional headend device, and may improve the transmission efficiency of the cable network.

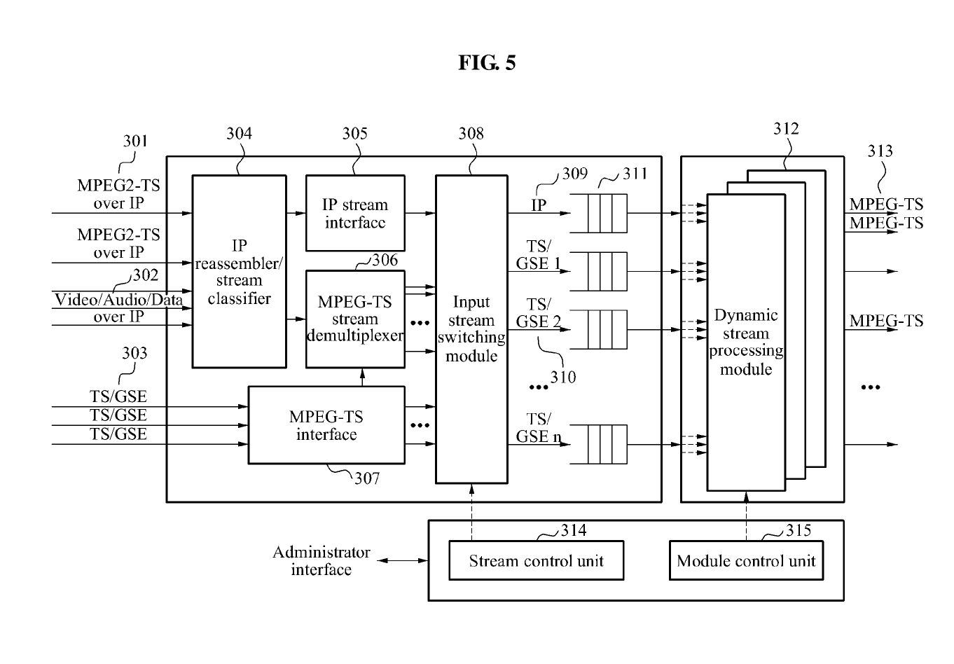

FIG. 5 is a diagram illustrating the input processor 206 of FIG. 4.

Referring to FIG. 5, an input processor 300 may classify a data stream input in the cable network based on a type of service flow. The input processor 300 may include an IP reassembler/stream classifier 304, an IP stream interface 305, an MPEG-TS stream demultiplexer 306, an MPEG-TS interface 307, and an input stream switching module 308.

The IP reaseembler/stream classifier 304 may receive an input of at least one of an MPEG-based data stream 301, for example, an IP data stream transmitted through an MPEG-2 TS interface, and an IP data stream 302 including video over IP, audio over IP, and data over IP. The IP reassembler/stream classifier 304 may classify the input data stream based on a type of service flow, and may transmit the classified data stream to the IP stream interface 305 or the MPEG-TS stream demultiplexer 306. The IP stream interface 305 may transmit the received data stream to the input stream switching module 308. The MPEG-TS stream demultiplexer 306 may split the received data stream into individual streams, for example, a video stream and an audio stream, and may transmit the split streams to the input stream switching module 308. The MPEG-2 TS interface 307 may receive an input of a TS/generic stream encapsulation (GSE)-based data stream from an external network, and may transmit the data stream to the input stream switching module 308.

The stream transmitted to the input stream switching module 308 may be transmitted to the dynamic stream processing module 312. In this instance, the control module may control the input stream switching module 308 and the dynamic stream processing module 312 in response to a control signal input by an administrator through an administrator interface.

Through a stream control unit 314, in response to the control signal by the administrator, the control module may interwork with the input stream switching module 308, and may identify a type of service flow of the stream output from the input stream switching module 308 and may control the dynamic stream processing module 312 based on the identified result.

Through a module control unit 315, the control module may transmit, to the dynamic stream processing module 312, an instruction for processing to be executed by the dynamic stream processing module 312. As described in the foregoing, the dynamic stream processing module 312 may include a plurality of stream processing modules. Through the module control unit 315, the control module may transmit, to the dynamic stream processing module 312, an instruction for a stream processing module to be used to convert the classified data stream among the plurality of stream processing modules.

The stream processed by the dynamic stream processing module 312 may be transmitted to the output stream switching module provisioned in advance. That is, the control module may transmit a provisioning signal to the output stream switching module after transmitting the instruction to the dynamic stream processing module 312.

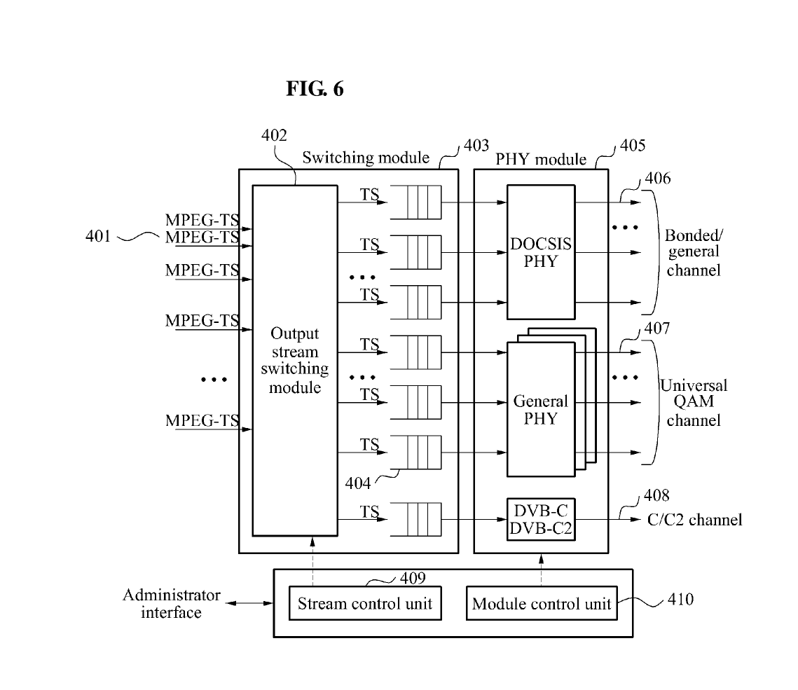

FIG. 6 is a diagram illustrating the output stream switching module 211 of FIG. 4.

Referring to FIG. 6, an output stream switching module 402 may receive an input of a stream 401 output from the dynamic stream processing module 312 of FIG. 5. In this instance, the input stream 401 may correspond to an MPEG TS-based stream. The output stream switching module 402 may execute provisioning in response to the provisioning signal of the control module, and may convert the stream 401 into an input stream for a PHY module 405.

The output stream switching module 402 may modulate the stream 401 into a stream associated with a standard for the PHY module 405, for example, DOCSIS EQAM, EQAM, video QAM, and coding schemes. The PHY module 405 may transmit the modulated stream to the cable network.

In this instance, the PHY module 405 may support a plurality of PHY schemes. The plurality of PHY schemes may include at least one of a DOCSIS PHY scheme, a general PHY scheme, and a DVB-C/DVB-C2 scheme. The PHY module 405 may transmit a stream 406 through a bonded/general channel, a stream 407 through a universal QAM channel, and a stream 408 through a C/C2 channel, through the plurality of PHY schemes.

To support the plurality of PHY schemes, the PHY module 405 may include a plurality of PHY modules. Also, through a stream control unit 409, in response to a control signal input by an administrator, the control module may select a predetermined PHY module, for example, a DOCSIS PHY module, and may control the output stream switching module 402 to convert the stream 401 into a stream associated with an input standard for the predetermined PHY module, for example, the DOCSIS PHY module. Through a module control unit 410, the control module may connect the predetermined PHY module to the output stream switching module 402.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard discs, floppy discs, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

The present invention proposes a modular headend device to process a stream using a to transmission standard for a PHY module through a passive stream switching module and a dynamic packet processing module. The present invention may provide a video transport device with economical efficiency and minimization for processing various types of video service flows input through a headend of a cable network. In particular, the present invention uses a packet processing module operating based on a network transmission service and a transmission standard and a PHY module applicable to various PHY standards, to provide and manage a cable network transmission service more flexibly. Also, the present invention may support network evolution through addition of network functions.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A headend device for a cable network comprising:
an input processor to classify a data stream input in the cable network based on a type of service flow;
a dynamic stream processing module to convert the classified data stream into a stream associated with a transmission standard for the cable network through a scheme corresponding to the type of service flow; and
an output stream switching module to output the stream converted by the dynamic stream processing module as an input for a physical layer (PHY) module.

2. The headend device of claim 1, wherein the dynamic stream processing module converts the classified data stream into a stream associated with a moving picture experts group-transport stream (MPEG-TS) standard through the scheme corresponding to the service flow type.

3. The headend device of claim 1, wherein the dynamic stream processing module comprises a plurality of stream processing modules to convert the data stream classified by the input processor into a stream associated with a transmission protocol for a hybrid fiber coaxial (HFC) cable network through different schemes.

4. The headend device of claim 3, wherein the plurality of stream processing modules is installed the dynamic stream processing module using a plug-in technique.

5. The headend device of claim 3, wherein the plurality of stream processing modules includes at least one of a first module to process a data over cable service interface specification (DOCSIS) header of a data stream input via an Internet Protocol (IP) network, a second module to perform a switched digital video (SDV) function on an input video stream through communication with an electronic program guide (EPG) server, and a third module to execute header processing for channel bonding.

6. The headend device of claim 3, further comprising:
a control module to transmit, to the dynamic stream processing module, an instruction for a stream processing module to be used to convert the classified data stream among the plurality of stream processing modules.

7. The headend device of claim 6, wherein the control module transmits a provisioning signal to the output stream switching module after transmitting the instruction.

8. The headend device of claim 6, wherein the control module selects a predetermined PHY module among a plurality of PHY modules, and controls the output stream switching module to output the data stream converted by the dynamic stream processing module as an input for the predetermined PHY module.

9. The headend device of claim 8, wherein the control module connects the predetermined PHY module among the plurality of PHY modules to the output stream switching module.

10. A method of operating a headend device for a cable network, the method comprising:
classifying a data stream input in the cable network based on a type of service flow;
converting the classified data stream into a stream associated with a transmission standard for the cable network through a scheme corresponding to the type of service flow; and
outputting the converted data stream as an input for a physical layer (PHY) module.

11. The method of claim 10, wherein the converting of the classified data stream into the stream associated with the transmission standard for the cable network comprises converting the classified data stream into the stream associated with the transmission standard for the cable network using a stream processing module supporting a service flow type of the classified data stream among a plurality of stream processing modules.

12. The method of claim 11, further comprising:
transmitting an instruction for a stream processing module to be used to convert the classified data stream among the plurality of stream processing modules based on a control input by an administrator.
